(19) United States
(12) Patent Application Publication
(10) Pub. No.: US 2002/0169512 A1
(43) Pub. Date: Nov. 14, 2002

(54) Plate mover for crystallization data collection

(75) Inventor: Lansing J. Stewart, Bainbridge Island, WA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: deCODE Genetics ehf., Reykjavik (IS)

(21) Appl. No.: 10/144,438

(22) Filed: May 10, 2002

Related U.S. Application Data
(63) Continuation-in-part of application No. 09/631,185, filed on Aug. 2, 2000.
(60) Provisional application No. 60/290,460, filed on May 11, 2001.
(60) Provisional application No. 60/146,737, filed on Aug. 2, 1999.

(51) Int. Cl. G06F 19/00

(52) U.S. Cl. 700/100

(57) ABSTRACT

The plate mover, according to the present invention, is an integrated stage mover and stereo microscope which moves crystallization plates through the microscope field of view. A digital camera attached to the microscope can capture images of crystallization results as the crystallization plate is moved through the field of vision of the microscope. The plate mover is suitably controlled by a computer having a CPU and a memory, wherein a software application, such as Crystal Monitor™ resides in the computer. Crystal Monitor™ is a suitable software application for crystallization results data entry which can use voice recognition commands to enter a crystallization result in a database. Real-time images can be viewed on a computer monitor during operation of the plate mover. Suitably, an automatic observation feature causes the crystallization results in a plate with minimal user intervention.

### RELATED APPLICATIONS

This application claims the benefit of U.S. Provisional Application No. 60/290,460, filed on May 11, 2001, and is also a continuation-in-part of U.S. patent application Ser. No. 09/631,185, filed on Aug. 2, 2000, which claims the benefit of U.S. Provisional Application No. 60/146,737, filed on Aug. 2, 1999. The entire teachings of the above applications are incorporated herein by reference, although for the convenience of the reader, some parts may be repeated herein.

### FIELD OF THE INVENTION

The present invention is a plate mover used in data collection, and in particular the collection of crystallization trials results.

### BACKGROUND OF THE INVENTION

Macromolecular x-ray crystallography is an essential aspect of modern drug discovery and molecular biology. Using x-ray crystallographic techniques, the three-dimensional structures of biological macromolecules, such as proteins, nucleic acids, and their various complexes, can be determined at practically atomic level resolution. The enormous value of three-dimensional information has led to a growing demand for innovative products in the area of protein crystallization, which is currently the major rate limiting step in x-ray structure determination.

One of the first and most important steps of the x-ray crystal structure determination of a target macromolecule is to grow large, well diffracting crystals with the macromolecule. As techniques for collecting and analyzing x-ray diffraction data have become more rapid and automated, crystal growth has become a rate limiting step in the structure determination process.

Vapor diffusion is the most widely used technique for crystallization in modem macromolecular x-ray crystallography. In this technique, a small volume of the macromolecule sample is mixed with an approximately equal volume of a crystallization solution. The resulting drop of liquid (containing macromolecule and dilute crystallization solution) is sealed in a chamber with a much larger reservoir volume of the crystallization solution. The drop is kept separate from the reservoir, either by hanging from a glass cover slip or by sitting on a tiny pedestal. Over time, the crystallization drop and the reservoir solutions equilibrate via vapor diffusion of the volatile species. Supersaturating concentrations of the macromolecule are achieved, resulting in crystallization in the drop when the appropriate reservoir solution is used.

The process of growing biological macromolecule crystals remains, however, a highly empirical process. Macromolecular crystallization is a hyperdimensional phenomena, dependent on a host of experimental parameters including pH, temperature, and the concentration of salts, macromolecules, and the particular precipitating agent (of which there are hundreds). A sampling of this hyperspace, via thousands of crystallization trials, eventually leads to the precise conditions for crystal growth. Thus, the ability to rapidly and easily generate many crystallization trials is important in determining the right conditions for crystallization. Also, since so many multidimensional data points are generated in these crystallization trials, it is imperative that the experimenter be able to accurately record and analyze the data so that promising conditions are pursued, while no further time, resources, and effort are spent on negative conditions.

Recently, an international protein structure initiative has taken shape with the goal of determining the three dimensional structures of all representative protein folds. This massive undertaking in structural biology which may some day rival the human genome sequencing project in size and scope, is estimated to require a minimum of 100,000 x-ray structure determinations of newly discovered proteins for which no structural information is currently available or predicted. For perspective, the total number of reported novel crystal structures determined to date (spanning nearly 50 years of work) is only approximately 10,000.

Using existing methods for the crystallization of proteins (random screens of conditions) the protein structure initiative will require a minimum of approximately 100 million crystallization trials. In addition the biological information gleaned from genomic research in the protein structure initiative are expected to create even more demand for structural information. Specifically, the biotechnology and pharmaceutical industries are estimated to require upwards of ten fold more protein crystallization experiments (one billion) as a result of research and structure based drug design and the use of crystallized therapeutic proteins. This would require that each of the approximately 500 macromolecular crystallography labs worldwide be responsible for setting up approximately 2000 crystallization trials every working day of the year for five years. Currently, there is no known device available for collecting for analysis macromolecular crystallization data on this scale. Thus, there is a need for a device that permits the efficient capture and storing of large amounts of crystallization trial data information.

Heretofore, there has been a lack of hands-free crystallization trials results collection. The present invention provides a hands-free apparatus to move a crystallization plate across the field of view of a microscope with minimal user intervention.

### SUMMARY OF THE INVENTION

The plate mover, according to the present invention, is an integrated stage mover and stereo microscope which moves crystallization plates through the microscope field of view. A digital camera attached to the microscope can capture images of crystallization results as the crystallization plate is moved through the field of vision of the microscope.

Other systems typically offer a digital camera. However, Applicants have found that a microscope facilitates the observations of crystals to a level unmatched by digital cameras. For example, there is a need to eventually “harvest” the grown crystals from a plate. Applicants have found that a person can perform this harvesting more easily by observing the well directly through a microscope rather than via a video screen. The resolution of most CCD cameras (if not all) is limited when compared to a that of a microscope. Thus, the user can make out more details using a microscope. Finally, full motion is hard to observe on a video screen due to the effect of discrete frames, which typically are refreshed at a rate ten to twenty frames per second, presenting a more or less jumpy display that is difficult to follow. A microscope provides full motion to the user in real time, without the degradation caused by the discrete frames.

Furthermore, the stereo microscope of at least one embodiment of the present invention, provides 3-D information that a 2-D video screen cannot duplicate. This is important in crystallization because the user is not looking at a 2-D slide, but rather is looking at 3-D drops of solution. These drops are often a few millimeters thick. The stereo microscope provides the user an unmatched ability to observe and recognize crystal formation within these drops.

To manufacture a plate mover with a standard off-the-shelf microscope, the microscope is cut in half so that the phototube portion is separated from the base portion. Holes may then be tapped into the microscope parts so that they can be mounted on a specially-designed plinth.

Another advantage of an embodiment of the present invention is that speech input can be used to direct the movement of the plate/tray, thus providing complete hands-off operation, so that the user can concentrate on his examination of the various solutions.

Another advantage of an embodiment of the present invention is that crystallization trial and results data are stored in a Structured Query Language (SQL) database. SQL is a standard database programming language. Thus, queries can be composed easily by anyone experienced in SQL, without having to learn a new language.

Preferably, trial results are presented pictographically, which allows a user to “see” images of rather than read text about the results. Pictographs are highly intuitive and can capture greater than 95 percent of all standard crystallization trial results.

The invention plate mover is suitably controlled by a computer having a CPU and a memory, wherein a software application, such as Crystal Monitor™ resides in the computer. Crystal Monitor™ memory is a suitable software application for crystallization results data entry which can use voice recognition commands to enter a crystallization result in a database. The software application can be obtained from Emerald BioStructures, Inc. of Bainbridge Island, Wash. The software is described in U.S. patent application Ser. No. 09/631,185, filed on Aug. 2, 2000, the specification of which is herein expressly incorporated by reference. Real-time images can be viewed on a computer monitor during operation of the plate mover. Suitably, an automatic observation feature can cause the plate mover to automatically move the crystallization plate to capture images of crystallization results in a plate with minimal user intervention.

Accordingly, a plate mover for use in collecting crystallization data includes a microscope (e.g., a stereo microscope), a translational stage, a memory containing computer program code and a CPU which executes the program code. The translational stage moves a crystallization plate (tray) containing an array of crystallization wells through the microscope's field of view. The CPU controls the translational stage responsive to user input, and is further responsive to crystallization trial data and crystallization result data.

Trial data may include information regarding the crystallization conditions to be used in a crystallization trial, including but not limited to, pH, temperature, and the concentration of salts, macromolecules, the particular precipitating agent and so on. Crystallization result data may include crystal type, crystal size, crystal shape, crystal count, etc. In one embodiment, crystallization trial data, and crystallization results data are stored in a SQL database.

In one embodiment, when crystallization trial data is input into the system, a pictograph representing the result appears in a crystallization well as represented in a graphical user interface (GUI).

Speech input, keyboard input and cursor/button input may be used to control, through the CPU, the translational stage.

The CPU may provide an automatic observation feature in which the plate mover automatically moves the crystallization plate (via the translational stage) to capture images of all crystallization results in the plate with minimal user intervention.

An embodiment of the invention further comprises a plinth that supports the microscope and translational stage. The plinth itself includes a platform, a phototube mount on which the microscope's phototube is mounted, and a structural member connecting the platform to the mount. For example, the structural member may be a substantially vertical support bar, or a rectangular frame. The base of the microscope is separated from the microscope phototube post, and the base is then mounted onto the plinth platform. The translational stage is then supported by the microscope base.

A digital camera may be attached to the microscope to capture images of crystallization results as the plate is moved. The CPU may receive the captured images and store them in a database, which may be the same database in which the crystallization trial data and crystallization results data are stored. Furthermore, the CPU may display the captured images on a computer monitor or other similar display device for viewing, in real time, during operation of the plate mover. An image may be captured in response to a user voice command, or alternatively, in response to a user clicking on (selecting) a representation of the well to be imaged and then clicking on (selecting) a capture command button within a graphical user interface.

A foot-controlled focus controller may be provided to allow hands-free focusing of the microscope.

In one embodiment, the translational stage has a first driver which moves the stage along a first axis, and a second driver which moves the stage along a second axis. The first axis is preferably perpendicular to the second axis.

The translational stage may be automatically positioned so that a selected well is centered in the microscope viewing field. The selected well may be selected, for example, by voice command, by clicking on an image of a well displayed on a computer monitor using a cursor control device, or by keyboard entry.

A joystick or similar controller may be provided for making fine adjustments so that a feature which is not in the center of a well can be viewed. After fine adjustments have been made, a user can click on (select) the representation of the well to move the plate mover back to the center of the well.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a schematic of an embodiment of the hardware configuration according to the present invention.

FIG. 2 shows a schematic of an embodiment of a platemover according to the present invention.

FIG. 3 is a view of the plate mover constructed according to the present invention.

FIG. 4 is a view of a plinth with microscope base constructed according to the present invention.

FIG. 5 is a view of a plinth constructed according to the present invention.

FIG. 6 is a view of a phototube mount constructed according to the present invention.

FIG. 7 is a view of a plinth constructed according to the present invention.

FIG. 8 is a view of a translational stage used in the present invention.

FIG. 9 is a view of a plinth and a microscope base constructed according to the present invention.

FIG. 10 is a view of the plinth and structural members constructed according to the present invention.

FIG. 11 is a view of the plinth and a translation stage constructed according to the present invention.

FIG. 12 is a view of the plinth and phototube constructed according to the present invention.

FIG. 13 shows a GUI for a trial observation recording tab for an active session according to the present invention.

FIG. 14 shows a GUI for a plate mover builder according to the present invention.

FIG. 15 is a view of the plate mover constructed according to the present invention.

FIG. 16 shows a GUI for a trial observation recording tab according to the present invention.

FIG. 17 shows a GUI for a digital image builder according to the present invention.

FIGS. 18A-18E are various views illustrating an alternate embodiment of the present invention using a different microscope from that shown in FIG. 3.

### DETAILED DESCRIPTION OF THE PREFERRED EMBODIMENT

A description of preferred embodiments of the invention follows.

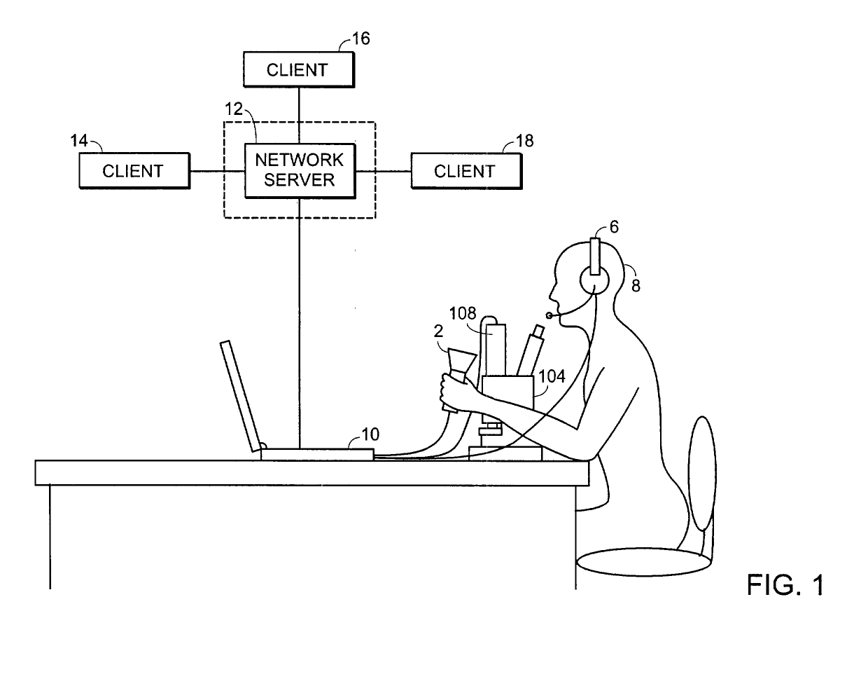

FIG. 1 illustrates a typical hardware configuration for implementing the present invention. At least one client computer 10 may be a stand alone computer, or more preferably, is connected along with a plurality of other client computers 14, 16 and 18 to a network server 12 by a local area network (LAN). The client computers can be laptop or desktop computers (or other computer if desired).

As is conventional, the computer 10 includes a cursor control device and a keyboard (not shown). The computer may have a mouse as the cursor control device. Attached to each client computer 10, 14, 16, 18 via suitable interfaces are a number of peripheral devices including (i) a barcode scanner 2, (ii) a crystallization trial observation device, such as a plate mover which includes a microscope 104 and a positioning mechanism for positioning the wells of a crystallization trial tray (plate) for viewing by a user, (iii) a digital camera 108 and (iv) a microphone headset 6. The microphone headset 6 provides audio speech input and audio feedback. Alternatively, a table top microphone and speaker can be used.

FIG. 1 also shows a user 8 seated at the viewing microscope 104. The microscope 104 may be fitted with a digital camera 108 for image capture of the crystallization trial data that is also observable through the microscope 104. The user may use the barcode scanner 2 to read a barcode on a crystallization trial tray prior to the tray being mounted on the positioning mechanism. This enables quick and accurate identification of the trial number.

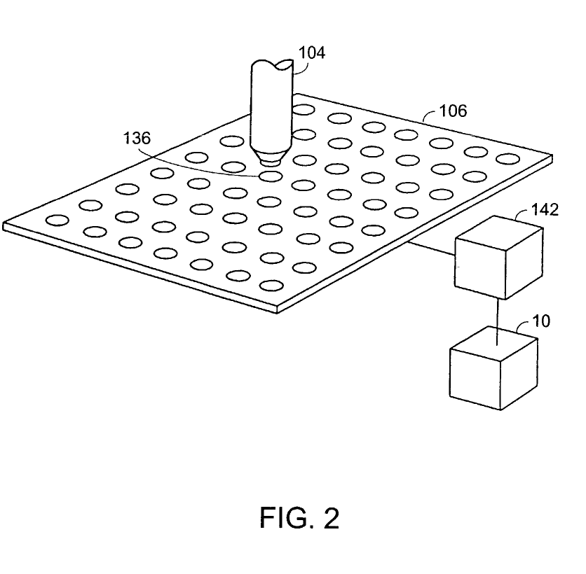

As shown in FIG. 2 and described below, the positioning mechanism is an electromechanical mechanism that includes a tray or plate 106 whose position is controlled by x-y transducers 142. The position of the x-y transducers 142 is controlled by client computer 10. The client computer 10 can control the position of the plate 106 so that the desired well 136 can be seen through the microscope 104 and/or photographed by the digital camera 108.

Software executing on the client computer 10 creates crystallization trial data for storage in a relational database that, preferably, is stored on the network server 12. The software includes a plurality of graphical user interfaces (GUIs) that provide user interfaces with various database managers which are described in U.S. patent application Ser. No. 09/631,185, filed on Aug. 2, 2000, incorporated by reference herein.

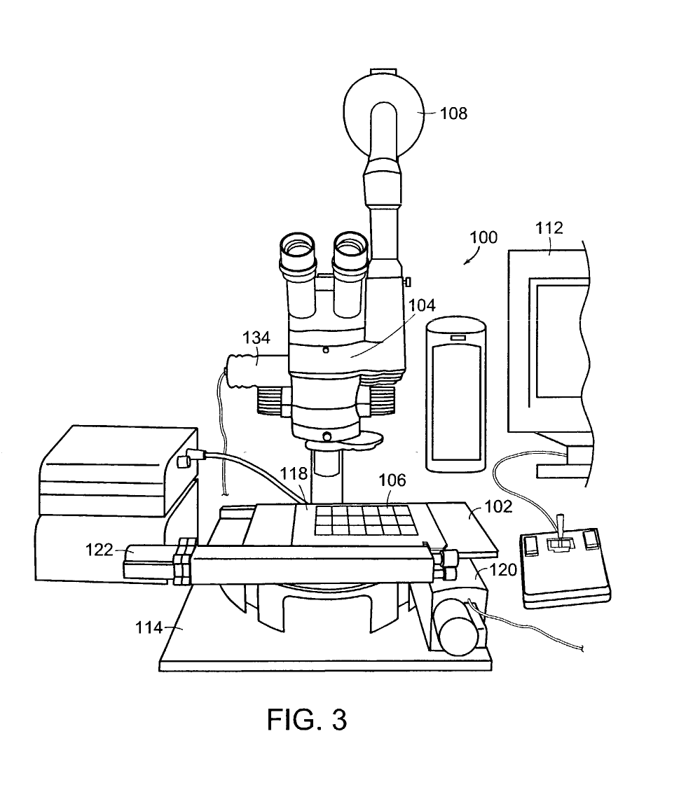

FIG. 3 illustrates a plate mover 100 constructed according to the present invention. The plate mover 100 according to the present invention includes a translational stage mover 102 and stereo microscope 104, which moves a crystallization plate 106 through the microscope field of view. A digital camera 108 is optionally attached to the microscope 104 to capture images of crystallization results as the plate 106 is moved.

The plate mover 100 is suitably controlled by a computer having a CPU and a memory wherein a software application for crystallization results data entry, such as CRYSTAL MONITOR resides therein.

Real-time images can be viewed on a computer monitor 112 during operation of the plate mover 100. Suitably, an automatic observation feature can cause the plate mover 100 to automatically move the crystallization plate 106, to capture images of all crystallization results in a plate 106 with minimal user intervention.

The plate mover 100 includes (a) a stereo microscope 104, such as Leica Microsystems AG's MS5 stereo microscope shown in FIG. 3, (b) a suitable stage mover 102, such as a Prior Scientific, Inc.'s XY translational stage, (c) a suitable digital camera 108, such as a Pixera Corporation digital camera, and (d) a plinth 114, suitably made from steel or the like. The plinth 114 according to the present invention suitably holds the translational stage 102 and the microscope 104.

Referring still to FIG. 3, a crystallization plate 106 is shown on the translational stage 102. Aluminum plate inserts 118 are constructed according to the present invention to accommodate different crystallization plates 106 and mate with the stage 102.

The microscope 104 includes a focus controller 134 which can be attached to foot pedals (not shown) for hands-free focusing. The hands-free focusing controller and hardware is supplied by Prior Scientific, Inc.

The translational stage 102 is connected to a power supply (not shown). The power supply can drive a first 120 and second 122 driver, to move the stage 102 in both X and Y directions. The plate inserts 118 are suitably made to mate with the translational stage 102.

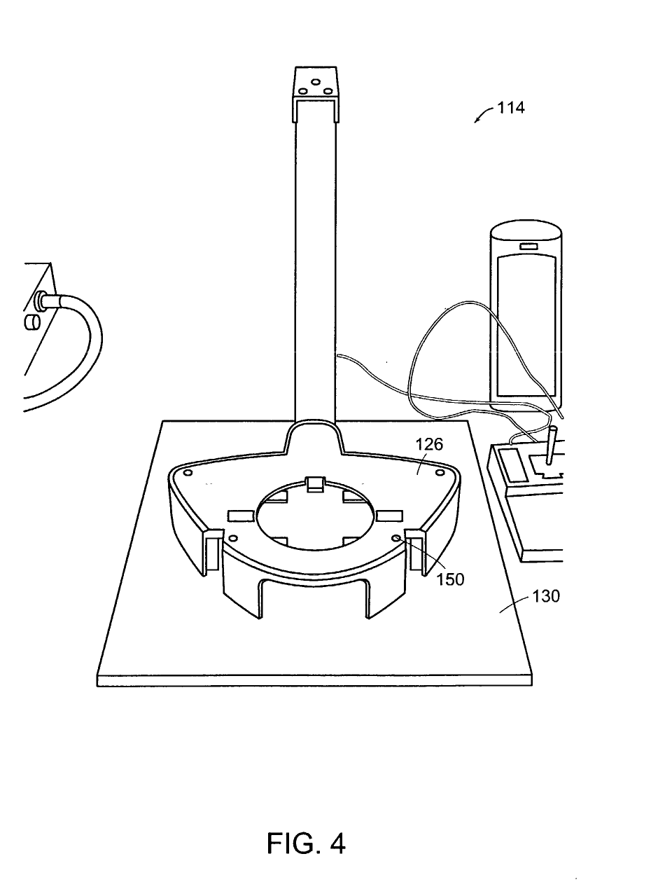

FIG. 4 illustrates the microscope base 126 and the plinth 114 of FIG. 3. The microscope base 126 has been separated from rest of the microscope 104, for example by sawing, and attached to the plinth 114 by suitable fasteners, such as screws to enable the construction of the plate mover 100. Mounting holes 150 are tapped into the base 126 for attaching the base 126 to the platform 130, and the translational stage 102 (shown in FIG. 3) to the base 126.

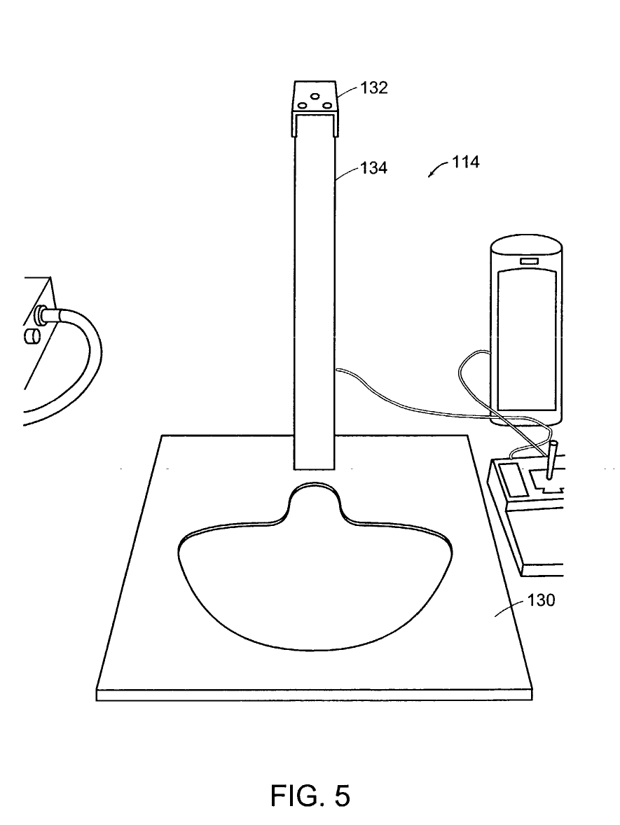

FIG. 5 illustrates the plinth 114, constructed according to the present invention. The plinth 114 includes a platform 130, a phototube mount 132, and a structural member 134 connecting the platform 130 to the mount 132. A suitable size for the platform 130 is about 16″ wide by 18″ long. However, other suitable sizes can also be used to provide a steady mount for the translational stage 102 and microscope 104.

The structural member 134 is suitably made to accommodate any suitable microscope. A suitable height of the structural member 134 is about 18″ high. However, other suitable heights can be used depending on the suitable microscope which is selected. The structural member 134 can be a steel box framed tube.

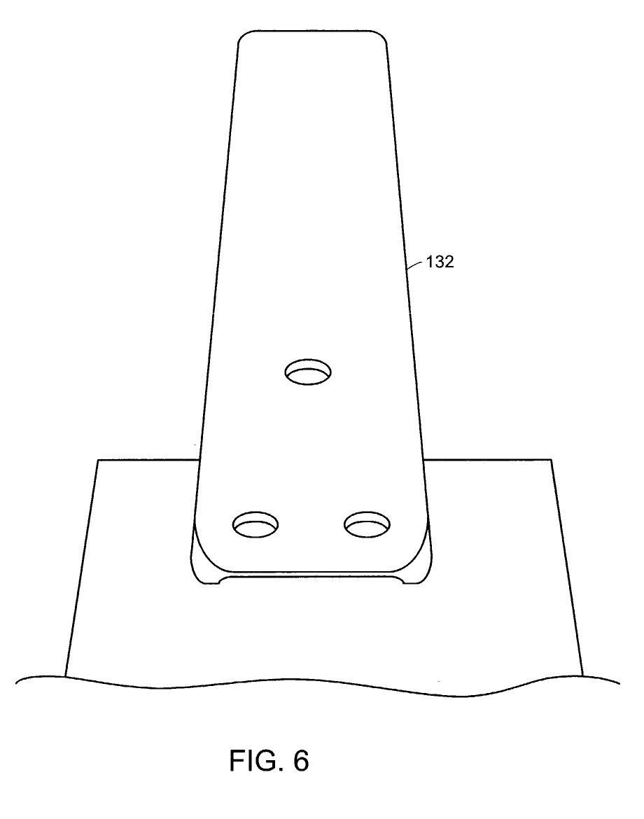

FIG. 6 illustrates a suitable phototube mount 132 constructed according to the present invention. A suitable mount 132 has three apertures disposed at the corners of an imaginary triangle and sized to accommodate the microscope phototube. However, other fastener configurations are possible, depending on the microscope which is selected.

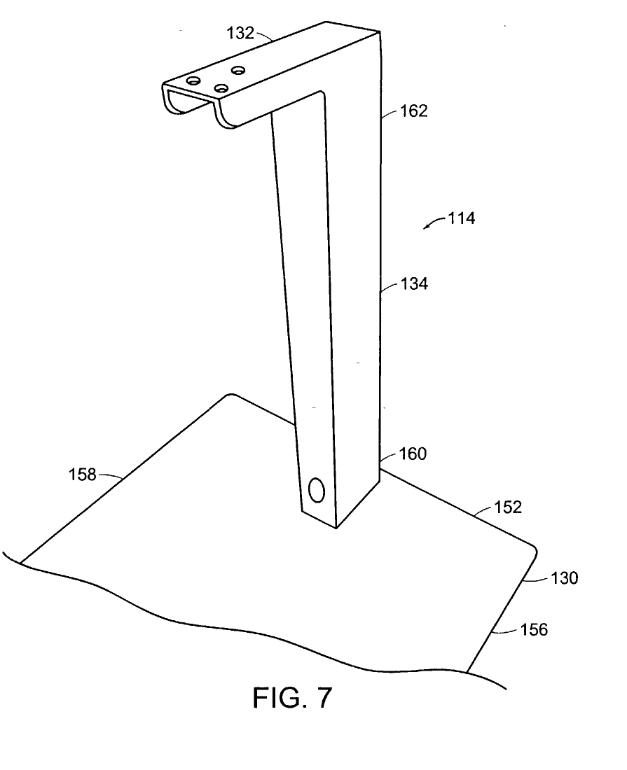

FIG. 7 is a perspective view of the plinth 114 of FIG. 3, constructed according to the present invention.

The plinth platform 130 is a rectangularly shaped member. Towards the back end 152 of the platform 130, the structural member 134 is mounted thereon at approximately midway from a first 156 and second 158 lateral sides of the platform 130. The structural member 134 includes a first 160 and a second 162 end wherein the first 160 end has been welded to the platform 130 as described above. The second end 162 includes the microscope mount 132. The microscope mount 132 is constructed so as to suitably hold the microscope phototube.

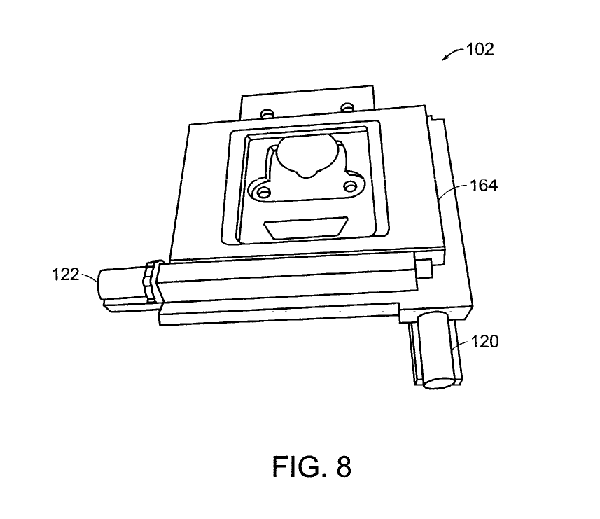

FIG. 8 illustrates the translational stage assembly 102 of FIG. 3. This stage includes a first 120 and a second 122 driver. The first driver 120 can move the stage 164 in a first direction, while the second driver 122 moves the stage 164 in a direction which is perpendicular to the first direction. A suitable translational stage is provided by Prior Scientific, Inc. The stage 164 includes an aperture for holding the plate inserts 118 (FIG. 3). A suitable translational stage measures 17″ wide by 17″ in length.

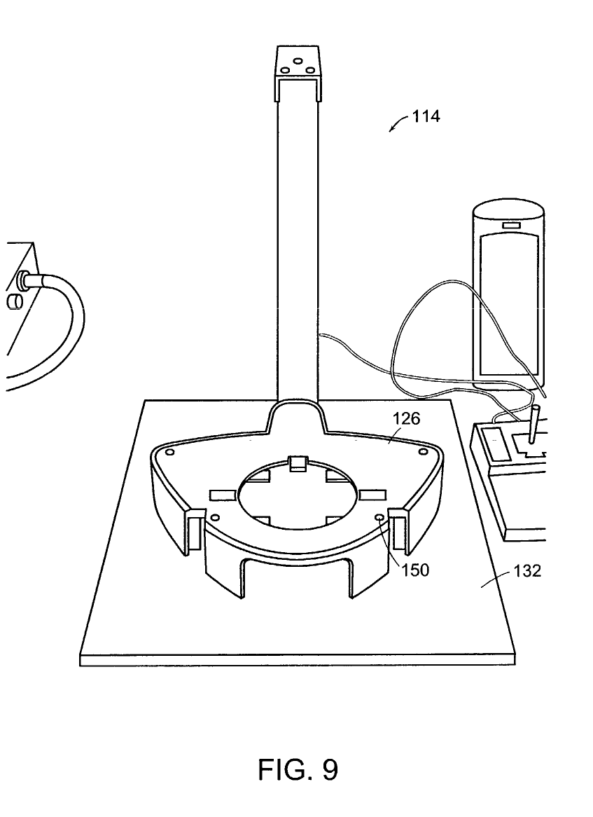

Referring now to FIG. 9, after the microscope base 126 has been separated from the microscope 104, the microscope base 126 is attached to the plinth mount 132 by suitable fasteners, such as screws through mounting holes 150 in microscope base 126.

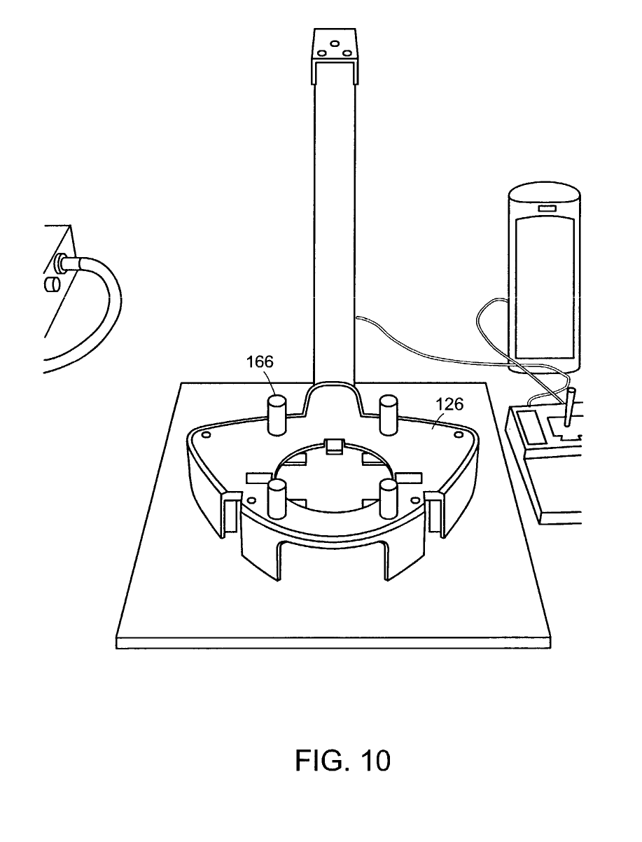

Referring now to FIG. 10, suitable spacers 166 are attached to the microscope base 126. The spacers 166 separate the microscope base 126 from the translational stage 102. A suitable material to use as a spacer is brass; however, other suitable metal or synthetic materials may also be used. The placement of the spacers 166 may suitably be determined based on the selected translational stage 102.

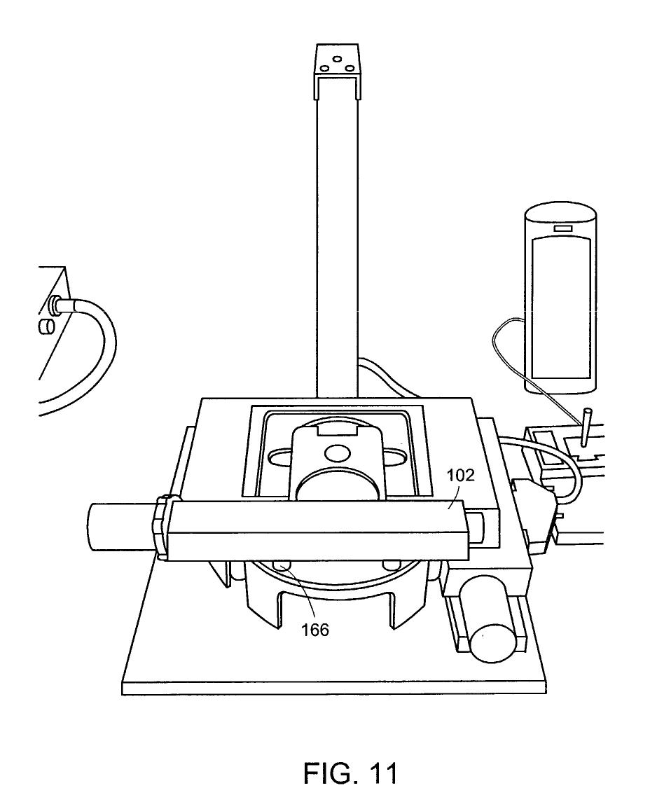

Referring now to FIG. 11, the translational stage 102 is mounted onto the spacers 166 and attached thereto by suitable fasteners, such as screws.

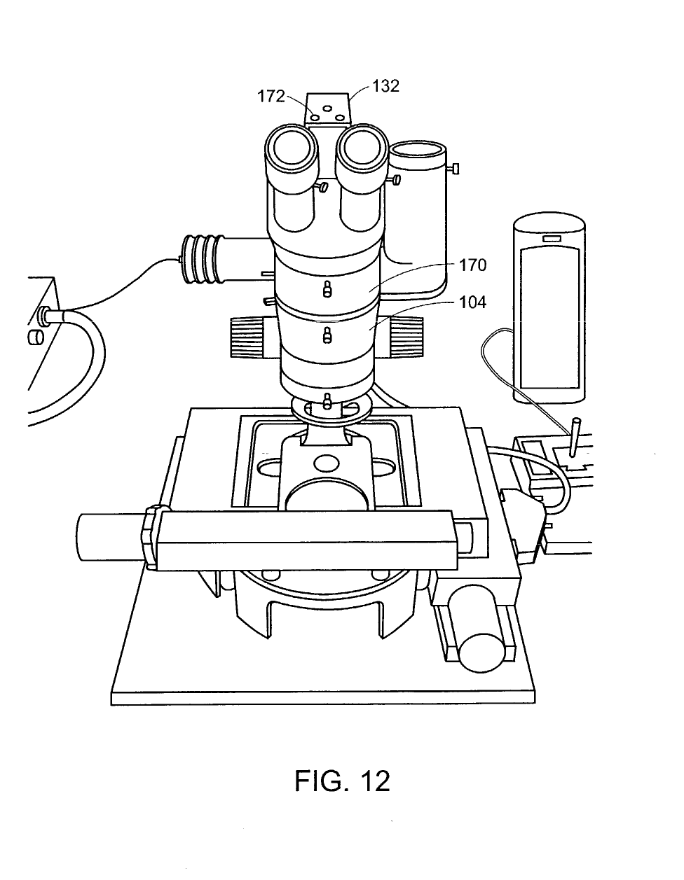

Referring now to FIG. 12, the microscope phototube 170 is attached to the plinth mount 132 by suitable fasteners 172, such as screws.

Assembling as illustrated in FIGS. 9-12, results in the hardware configuration of a plate mover of the present invention as shown in FIGS. 3 and 12.

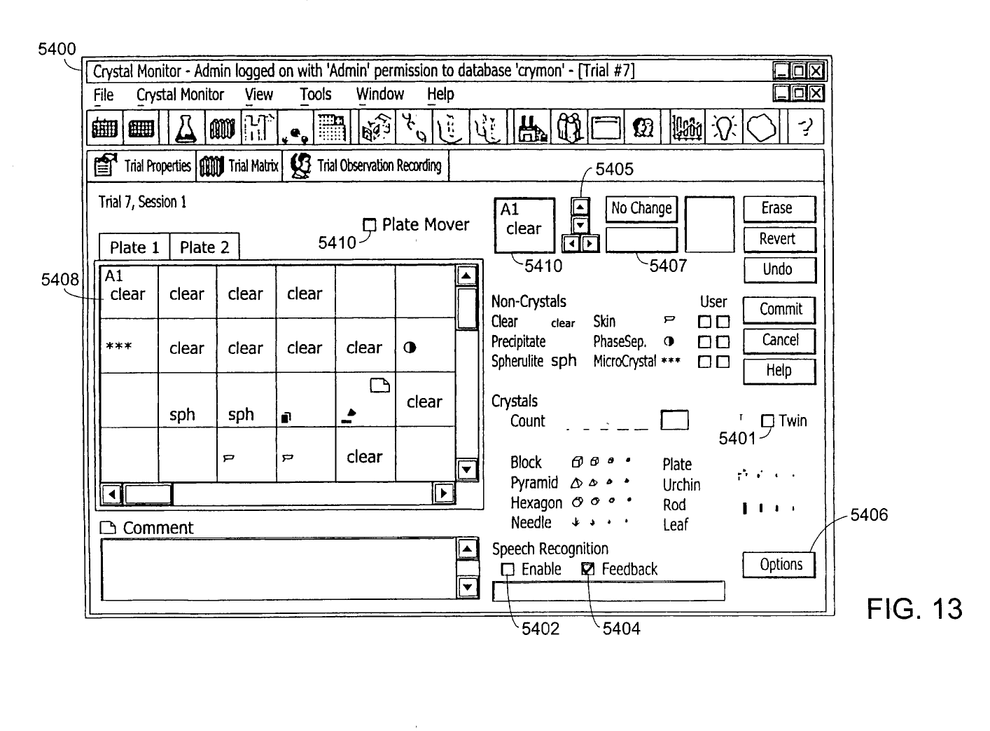

With regard to operation of the plate mover system of the present invention, FIG. 13 is a view of a “trial observation recording” dialog window 5400. A user has several options for entering crystallization results data.

A user can click on or otherwise select individual results buttons in the crystallization results control panel 5401, or a user can enter data by voice using speech recognition software that forms part of this invention and is more fully described below. In this regard, a user has the option of enabling speech recognition by checking a speech recognition check box 5402. A user also has the option of hearing the input by checking a feedback checkbox 5404. Speech recognition permits the user to maintain his focus on the microscope 104 and determining crystallization trial results during an observation session. This results in faster crystallization data collection as there is no physical motion required of the user, such as taking focus away from the microscope to write observations in a notebook. The audio feedback confirmation of the speech recognition commands ensures practically complete accuracy of the speech recognition.

In order to realize the full potential of the present invention's speech recognition capabilities, some settings may need to be adjusted. Selecting an options command button 5406 in the crystallization results control panel 5401 of the trial observation recording dialog window 5400 customizes the voice command settings while an observation session is active.

After customizing the voice commands, the user may choose to enable the plate mover. The automated plate mover allows precise, reproducible plate translations for recording crystallization observations. Preferably, the plate mover is controlled by cursor controller clicks over a particular well 5408, selected keyboard keys, or speech recognition.

Using the plate mover requires that crystallization trays be appropriately inserted into or mounted on a plate insert which fits into the microscope support structure. Preferably, software formed in accordance with the present invention comes preloaded with the positions of the trial wells (drop chambers) for all available crystallization trays or plates. New trays and/or plates are definable using the apparatus manager in the manner described in U.S. patent application Ser. No. 09/631,185.

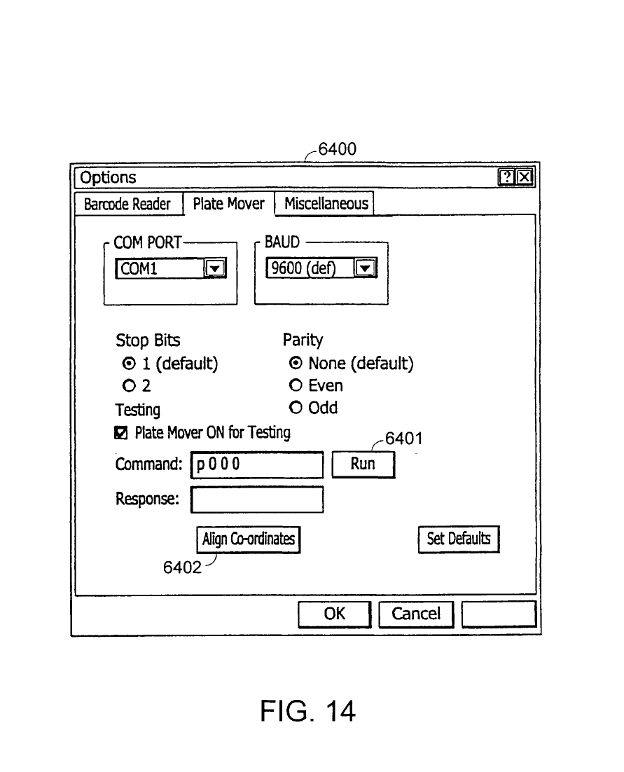

FIG. 14 illustrates an exemplary options dialog window 6400 which can be used to calibrate the plate mover. Calibration requires that a user place the plate insert with the plate or tray in the microscope stage so that a reference hole in the insert is in a predetermined position, i.e., the upper left corner, when the inserted plate is viewed from above. The user manually adjusts the plate mover using a joystick control until the reference hole is in the center of the viewing field of the microscope.

The plate calibration options dialog window 6400 also allows a user to test the plate mover by clicking on a run command button 6401. When a user selects the run command button 6401, followed by the align coordinates command button 6402, the plate mover is calibrated with pre-defined plate definitions.

Because the reference hole has the same position for all plate inserts, calibrating the plate mover for one type of plate insert calibrates the mover for all plate inserts. The plate mover can be recalibrated if the plate mover is jarred.

The plate mover can be used to view or record crystallization trials by a user opening the trial and checking the plate mover checkbox 5416 in the trial observation recording dialog window 5400 (FIG. 13). Since the type of crystallization plate used in the trial and its dimensions and well positions are stored in the database, selecting on a representation of a well using a cursor control device automatically positions the plate mover so that the selected well is centered in the microscope viewing field. A joystick (not shown) can be used for fine adjustments so that a feature which is not in the center of the well can be viewed. After making fine adjustments, selecting the well representation 5408 returns the plate mover to the center of the corresponding well.

In one embodiment, the plate mover moves in single well increments using the up, down, left, and right arrow keys of a keyboard. The plate mover can also be moved by voice commands during an active trial observation session. Suitable navigational voice commands are, but are not limited to: Next, Back, Well Left, Well Right, Well Up, Well Down, First Well, and Last Well. Alternatively, the up, down, left, and right arrow buttons 5405 in the results control panel 5401 (FIG. 13) can be used to move the plate mover during an active observation session.

It is understood that other commands for skipping wells or moving in multiple well increments are suitable.

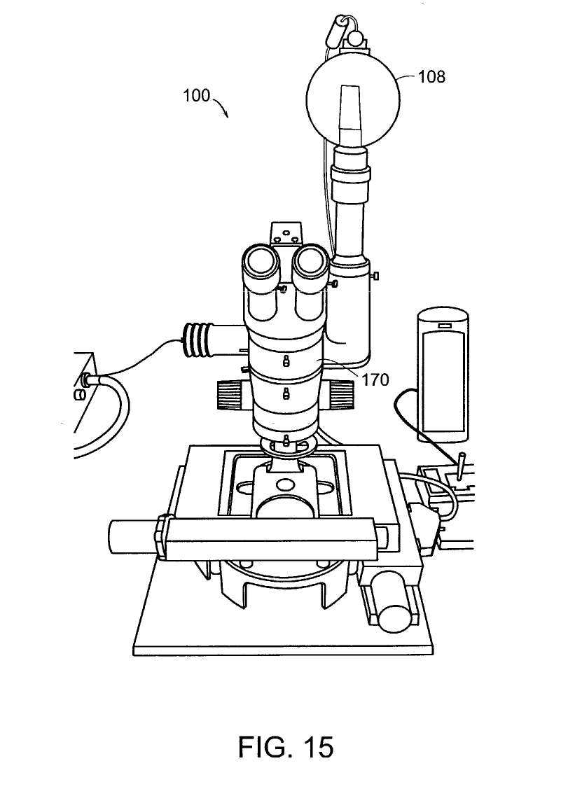

Referring now to FIG. 15, a suitable digital camera 108 is mounted on the microscope phototube 170. For example, a suitable digital camera is made by Pixera Corporation and is attachable to the microscope 104 with a common C-mount. Ancillary equipment such as cables, drivers, controllers, and power supplies can be attached at any stage or microscope, so as to enable the construction of a hands-free crystallization results data collection in combination with a suitable computer executable set of instructions.

Returning again to FIG. 13, the digital image camera 108 may be used to capture digital images of the crystallization results. An observation session must be active in order to take a digital image. When a user clicks an image command button 5407 in the crystallization results control panel 5401, an image capture options list is displayed.

The image capture options list allows a user to select the pixel resolution of the image to be captured. Preferably, all images are saved in JPEG format. A 320 by 240 pixel image requires about 200 kB of data storage, and a 1,260 by 960 pixel image requires about 3 MB of data storage.

After the pixel resolution is selected, an image is captured by a user clicking on the image and then clicking on a capture command button, or issuing a capture voice command. Several feedback beeps can be emitted, for example, to indicate to a user that the camera is preparing to capture an image. More beeps can be used to denote that a higher resolution image will be captured. A clicking shutter feedback sound can be emitted when the image is taken.

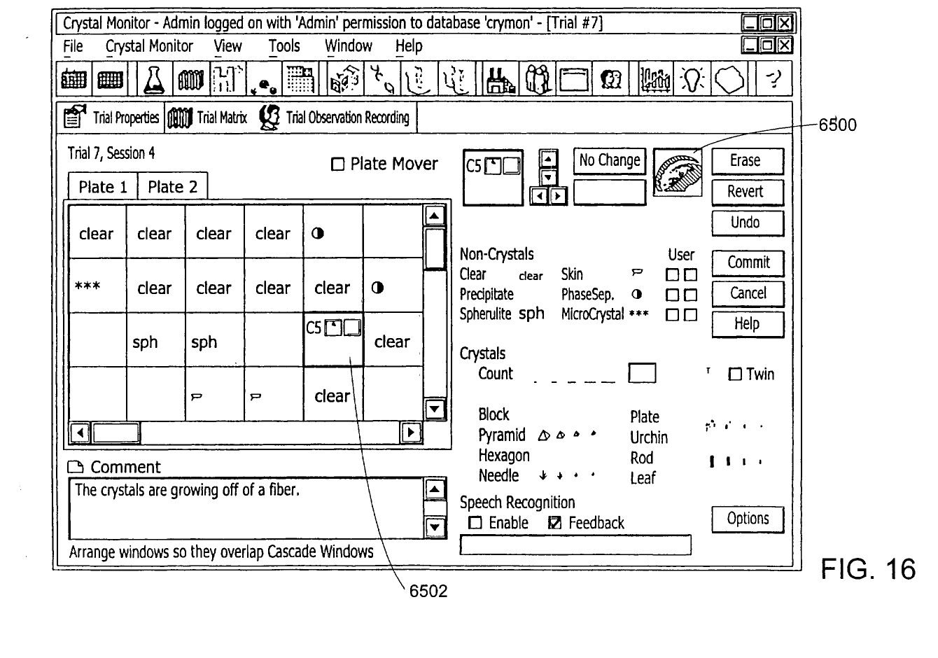

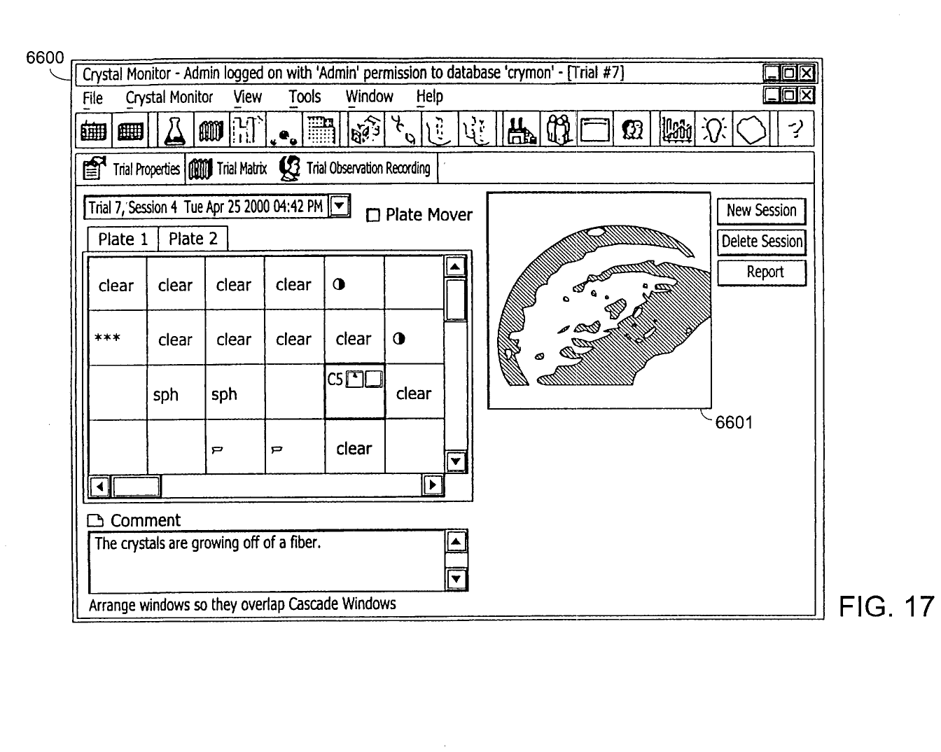

FIG. 16 shows a GUI for a trial observation recording tab according to the present invention. Preferably, the captured image appears in a thumbnail box 6500 in the crystallization results control panel, and an image capture icon 6502 appears in the related well in the trial template. Preferably, double clicking an image in the thumbnail box 6500 will automatically launch a program that creates a larger size view 6601 of the image as shown in FIG. 17. Preferably, the image is such that it can then be manipulated by any suitable graphics program and the edited version saved as a result.

When a result (crystallization trial data) is input, a pictograph representing the result appears in the crystallization well representation of the GUI. In one embodiment, up to six different crystallization results plus a comment and a digital image can be entered for a crystallization well during an observation session. When all the results for a well have been entered, the focus is advanced to the next well using the navigation commands next, back, well right, well left, well up, and well down. FIG. 13 is an example of what the crystallization results might look like.

Further, preferably, while the image is only capturable during an active observation session, any captured image is viewable during a review of the data produced during an observation session. Preferably, clicking on the image capture command button 5407 (FIG. 13) turns on an observed flag for the related well representation 5408, even if no other observations are recorded for that well.

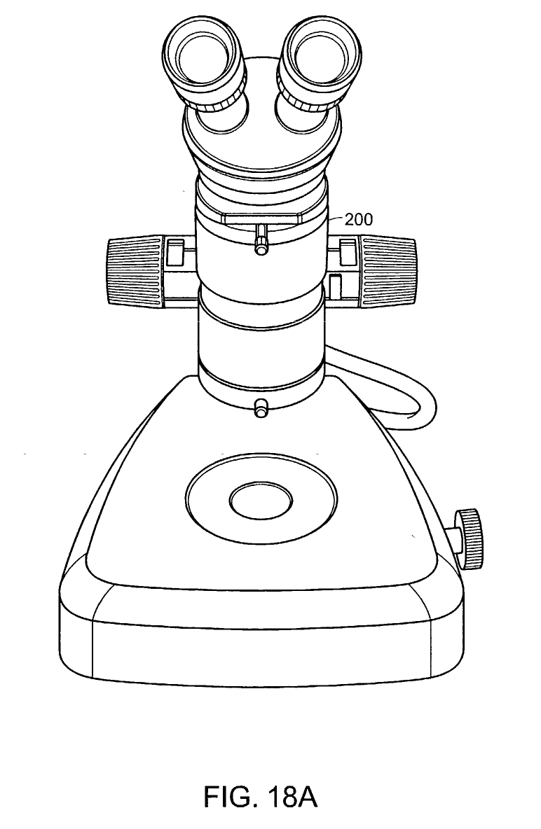

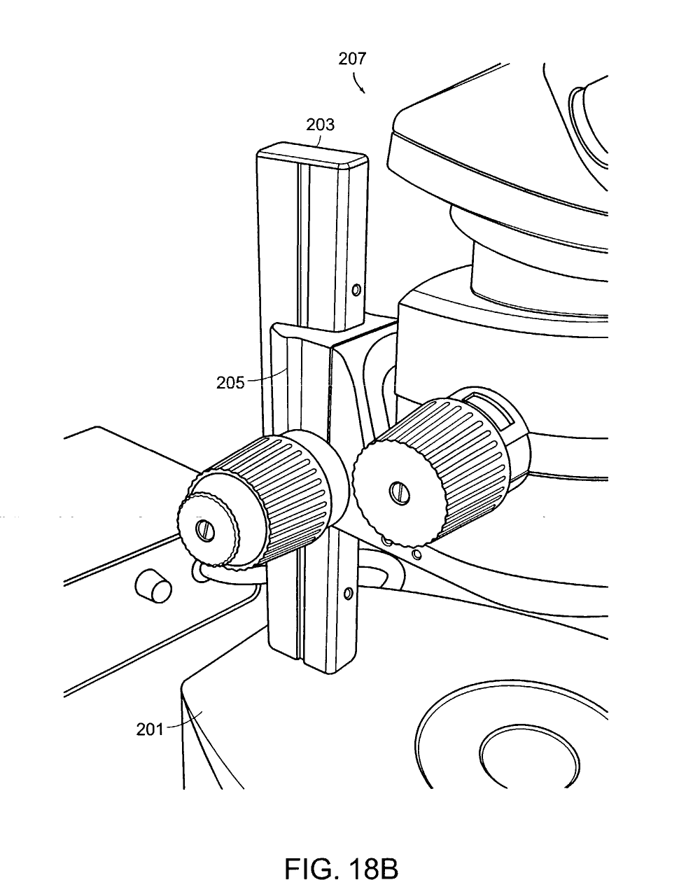

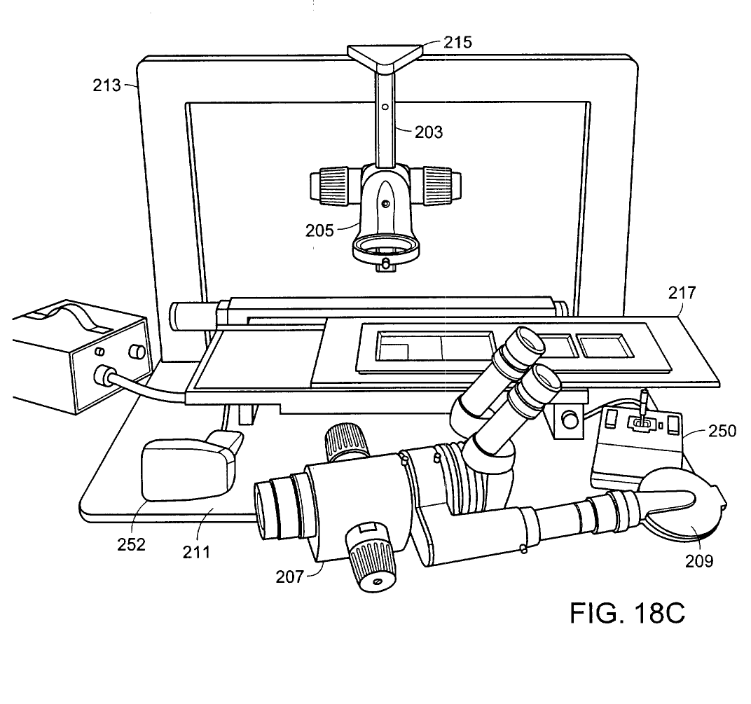

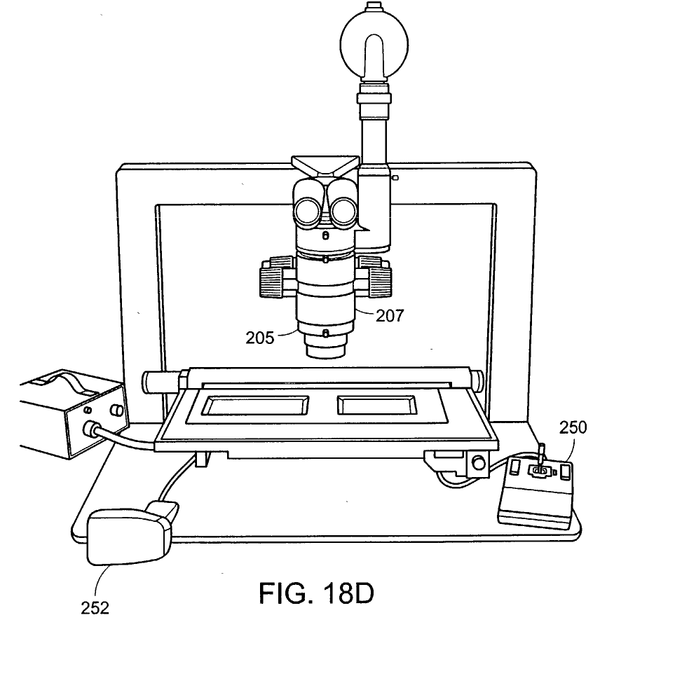

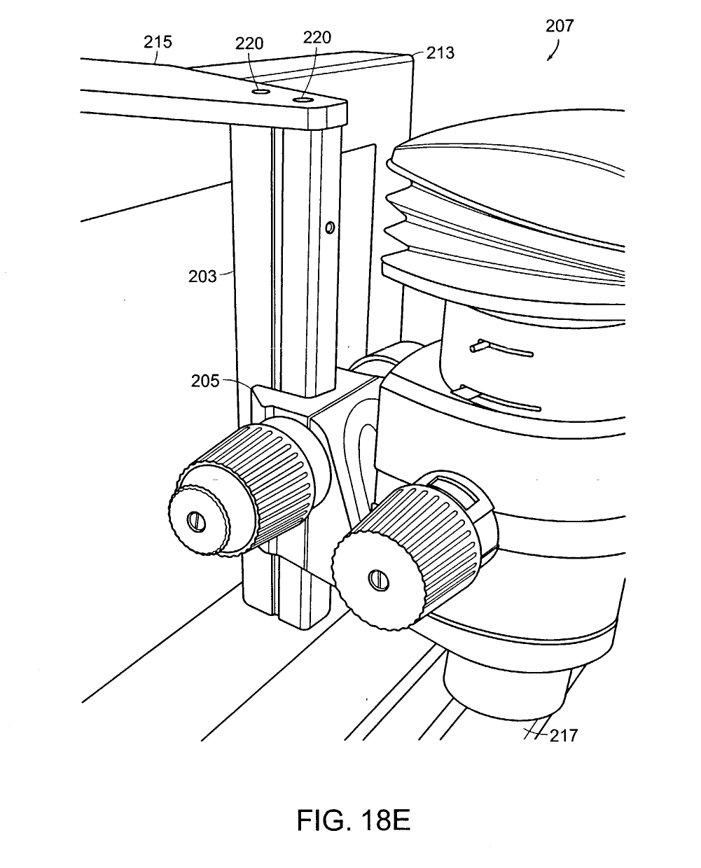

FIGS. 18A-18E are various views illustrating an alternate embodiment of the present invention using a different microscope from that shown in FIG. 3.

FIG. 18A, for example, illustrates a second suitable stereo microscope 104 for use in the present invention: a Leica LZ12.5 stereo microscope 200. However, any suitable stereo microscope can be incorporated into the plate mover 100 in accordance with the present invention.

FIG. 18B illustrates this microscope as it is purchased “off the shelf”. A post 203 on which the phototube holder 205 rides is integral with the base 201. The phototube 207 sits in the phototube holder 205.

FIG. 18C illustrates an embodiment of the present invention using this microscope. A plinth comprises a base 211 which provides stability. A rectangular frame 213 supports the phototube mount 215. Note that the post 203 has been severed from the microscope's base, by sawing it off in the case of this particular microscope model. Mounting holes are then tapped into the post 203, which is then attached to the plinth's phototube mount 215. The phototube holder 205 is then attached to the post 203, as normal. The phototube 207 will then sit in the phototube holder 205.

This figure shows the camera 209 attached to the phototube 207. Also shown is the translational stage 217, which is attached to the microscope base (not shown), which in turn is mounted to the platform 211.

Also shown in FIG. 18C are a bar code scanner 252 and a joystick 250.

FIG. 18D is another view of the invention with the phototube 207 mounted in the phototube holder 205.

FIG. 18E is yet another view showing how the post 203 is attached to the phototube mount 215 using, in this embodiment, three fasteners 220.

While this invention has been particularly shown and described with references to preferred embodiments thereof, it will be understood by those skilled in the art that various changes in form and details may be made therein without departing from the scope of the invention encompassed by the appended claims.

What is claimed is:

1. A plate mover for use in collecting crystallization data, comprising:
a microscope;
a translational stage which moves a crystallization plate through the microscope's field of view;
a memory containing computer program code; and
a CPU which, when executing the program code:
controls the translational stage responsive to user input, and
is responsive to crystallization trial data and crystallization result data.

2. The plate mover of claim 1, wherein, trial data includes information regarding the crystallization conditions to be used in a crystallization trial.

3. The plate mover of claim 1, wherein crystallization result data includes any of crystal type, crystal size, crystal shape and crystal count.

4. The plate mover of claim 1, further comprising:
a database for storing any of crystallization trial data, and crystallization results data.

5. The plate mover of claim 4, wherein the database is accessed with SQL queries.

6. The plate mover of claim 1, wherein when crystallization trial data is input, a pictograph representing the result appears in a GUI crystallization well.

7. The plate mover of claim 1, wherein the microscope is a stereo microscope.

8. The plate mover of claim 1, wherein the CPU controls the translational stage in response to speech input.

9. The plate mover of claim 8, wherein the CPU further controls the translational stage in response to any of: keyboard input; and cursor/button input.

10. The plate mover of claim 1, wherein the CPU provides an automatic observation feature in which the plate mover automatically moves the crystallization plate to capture images of all crystallization results in the plate with minimal user intervention

11. The plate mover of claim 1, further comprising:
a plinth that supports the microscope and translational stage.

12. The plate mover of claim 11, wherein the plinth comprises:
a platform;
a phototube mount on which the microscope's phototube is mounted; and
a structural member connecting the platform to the mount.

13. The plate mover of claim 12, wherein the structural member is substantially vertical.

14. The plate mover of claim 12, wherein the structural member is a substantially rectangular frame.

15. The plate mover of claim 12, wherein the base of the microscope is separated from the microscope phototube, the microscope base being supported by the plinth platform, and the translational stage being supported by the microscope base.

16. The plate mover of claim 1, further comprising:
a digital camera attached to the microscope to capture images of crystallization results as the plate is moved.

17. The plate mover of claim 16, wherein the CPU receives the captured images.

18. The plate mover of claim 17, wherein the CPU stores the captured images in a database.

19. The plate mover of claim 17, wherein the CPU displays the captured images on a computer monitor for viewing.

20. The plate mover of claim 19, wherein the images are displayed in real time.

21. The plate mover of claim 17, wherein real-time images are displayed on a computer monitor during operation of the plate mover.

22. The plate mover of claim 17, wherein an image is captured responsive to a user voice command.

23. The plate mover of claim 17, wherein an image is captured responsive to a user clicking on a representation of a well to be imaged and then clicking on a capture command button within a graphical user interface.

24. The plate mover of claim 1, further comprising:
a foot-controlled focus controller.

25. The plate mover of claim 1, wherein the translational stage comprises:
a first driver which moves the stage along a first axis; and
a second driver which moves the stage along a second axis.

26. The plate mover of claim 25, wherein the first axis is perpendicular to the second axis.

27. The plate mover of claim 1, wherein the translational stage is automatically positioned so that a selected well is centered in the microscope viewing field.

28. The plate mover of claim 27, wherein the selected well is selected by any of a voice command, clicking on a well displayed on a computer monitor using a cursor control device, and keyboard entry.

29. The plate mover of claim 1, further comprising a joystick for making fine adjustments so that a feature which is not in the center of a well can be viewed.

30. The plate mover of claim 29, wherein, after fine adjustments have been made, clicking over a representation of the well causes the plate mover to return to the center of the well.

31. A plate mover for use in collecting crystallization data, comprising:
a microscope;
a translational stage which moves a crystallization plate through the microscope's field of view;
a memory containing computer program code; and a CPU which, when executing the program code:
controls the translational stage responsive to user input,
receives via a dialog window, trial data, said trial data including information regarding the crystallization conditions to be used in a crystallization trial,
stores the received trial data in a database,
receives, via a verbal input device, crystallization result data, said data including crystal type, crystal size, crystal shape and crystal count, and
stores the received crystallization result data in the database.

32. An apparatus for creating a database containing the results of crystallization trials, said apparatus comprising:
an observation system for observing the results of crystallization trials, the observation system comprising a plate mover, the plate mover comprising:
a microscope,
a translational stage which moves a crystallization plate through the microscope's field of view, and
a plinth supporting the microscope and translational stage;
a data input system for inputting the results of observing crystallization trials and related information; and
a database generator coupled to said data input system for receiving the results of observing crystallization trials and related information and creating a database for storing the results of observing crystallization trials and related information.

33. A method for collecting crystallization data, comprising:
using a microscope to observe a plurality of sample wells in a crystallization plate;
using a translational stage to move the crystallization plate through the microscope's field of view;
controlling, from a CPU, the translational stage, responsive to user input, the CPU also being responsive to crystallization trial data and crystallization result data.

34. The method of claim 33, wherein trial data includes information regarding the crystallization conditions to be used in a crystallization trial.

35. The method of claim 33, wherein crystallization result data includes any of crystal type, crystal size, crystal shape and crystal count.

36. The method of claim 33, further comprising:
for storing any of crystallization trial data, and crystallization results data in a database.

37. The method of claim 36, wherein the database is accessed with SQL queries.

38. The plate mover of claim 33, wherein when crystallization trial data is input, a pictograph representing the result appears in a GUI crystallization well.

39. The method of claim 33, wherein the microscope is a stereo microscope.

40. The method of claim 33, wherein the CPU controls the translational stage in response to speech input.

41. The method of claim 40, wherein the CPU further controls the translational stage in response to any of: keyboard input; and cursor/button input.

42. The method of claim 33, further comprising under control of the CPU, automatically:
moving the crystallization plate to each well position and capturing images of all crystallization results in the plate with minimal user intervention

43. The method of claim 33, further comprising:
supporting the microscope and translational stage with a plinth, the plinth comprising a platform, a phototube mount on which the microscope's phototube is mounted, and a structural member connecting the platform to the mount.

44. The method of claim 43, wherein the base of the microscope has been separated from the microscope phototube, the microscope base being supported by the plinth platform, and the translational stage being supported by the microscope base.

45. The method of claim 33, further comprising:
using a digital camera, attached to the microscope, to capture images of crystallization results as the plate is moved.

46. The method of claim 45, further comprising:
receiving, at the CPU, the captured images.

47. The method of claim 46, the CPU storing the captured images in a database.

48. The method of claim 46, the CPU displaying the captured images on a computer monitor for viewing.

49. The method of claim 48, wherein the images are displayed in real time.

50. The method of claim 46, further comprising:
displaying real-time images on a computer monitor during operation of the plate mover.

51. The method of claim 46, further comprising:
capturing an image responsive to a user voice command.

52. The method of claim 46, further comprising:
capturing an image responsive to a user clicking on a representation of a well to be imaged and then clicking on a capture command button within a graphical user interface.

53. The method of claim 33, further comprising:
using a foot-controller to focus the microscope.

54. The method of claim 33, wherein the translational stage is controlled by:
a first driver which moves the stage along a first axis; and
a second driver which moves the stage along a second axis.

55. The method of claim 54, wherein the first axis is perpendicular to the second axis.

56. The method of claim 33, further comprising:
automatically positioning the translational stage is so that a selected well is centered in the microscope viewing field.

57. The method of claim 56, wherein the selected well is selected by any of a voice command, clicking on a well displayed on a computer monitor using a cursor control device, and keyboard entry.

58. The method of claim 33, further comprising:
using a joystick for making fine adjustments so that a feature which is not in the center of a well can be viewed.

59. The method of claim 58, further comprising:
after fine adjustments have been made, returning the plate mover to the center of the well responsive to a user clicking over a GUI representation of the well.

60. A method for use in collecting crystallization data, comprising:
using a microscope;
using a translational stage to move a crystallization plate through the microscope's field of view;
using a CPU to:
control the translational stage responsive to user input,
receive via a dialog window, trial data, said trial data including information regarding the crystallization conditions to be used in a crystallization trial,
store the received trial data in a database,
receive, via a verbal input device, crystallization result data, said data including crystal type, crystal size, crystal shape and crystal count, and
store the received crystallization result data in the database.

61. A method for creating a database containing the results of crystallization trials, said apparatus comprising:
observing the results of crystallization trials, the observation system comprising a plate mover, the plate mover comprising:
a microscope,
a translational stage which moves a crystallization plate through the microscope's field of view, and
a plinth supporting the microscope and translational stage;
inputting the results of observing crystallization trials and related information;
receiving the results of observing crystallization trials and related information; and
creating a database for storing the results of observing crystallization trials and related information.

62. A method for manufacturing a crystallization trial plate mover, comprising:
providing a plinth, the plinth comprising:
a platform for mounting a microscope base and of sufficiently large area to provide stability to the plate mover,
a phototube mount, and
a structural member connected at a first end to the platform, the phototube mount being attached to the structural member at a second end, above the platform;
separating a microscope base from a phototube;
attaching the microscope base to the platform;
attaching a translational stage to the base, the translational stage for moving a crystallization plate through the microscope's field of view; and
attaching the phototube to the phototube mount.

63. The method of claim 62, further comprising:
linking the translational stage to a CPU, such that the CPU controls movement of the translational stage, responsive to user input.

64. The method of claim 63, wherein the CPU controls the translational stage in response to speech input.

65. The method of claim 62, further comprising:
providing a database for storing any of crystallization trial data, and crystallization results data.

66. The method of claim 62, further comprising:
attaching a digital camera to the phototube to capture images of crystallization results as the plate is moved.

67. The method of claim 66, further comprising:
providing a database for storing the captured images.

68. The method of claim 66, further comprising:
means for displaying in real time the captured images on a computer monitor for viewing.

69. A crystallization trial plate mover, comprising:
a plinth, the plinth comprising:
a platform for mounting a microscope base and which of sufficiently large area to provide stability to the plate mover,
a phototube mount, and
a structural member connected at a first end to the platform, the phototube mount being attached to the structural member at a second end, above the platform;
a microscope having an integral base and phototube, the base having been separated from the phototube, wherein the base is attached to the platform, and the phototube is attached to the phototube mount; and
a translational stage attached to the base.

70. A system for collecting crystallization data, comprising:
means for directly observing a plurality of sample wells in a crystallization plate;
moving means for moving the crystallization plate through a field of view;
means for controlling, from a CPU, the moving means, responsive to user input, the CPU also being responsive to crystallization trial data and crystallization result data.

71. A crystallization trial plate mover, comprising:
support means comprising:
platform means for mounting a microscope base and being of sufficiently large area to provide stability to the plate mover,
phototube mount means, a phototube being mounted onto the phototube mount means, the phototube having been separated from the microscope base, and
structural member means for supporting the phototube mount means above the platform means; and
moving means attached to the base, said moving means for moving a crystallization plate through a field of view.
